(19) United States
(12) Patent Application Publication
(10) Pub. No.: US 2018/0108267 A1
(43) Pub. Date: Apr. 19, 2018

(54) METHODS AND A SYSTEMS FOR PROVIDING PLAY-BASED LEARNING IN ORDER TO ENHANCE SKILLS AND FURTHER MONITORING THE ENHANCED SKILLS THROUGH A COMPUTING DEVICE

(71) Applicant: Mr. Scott David Siebers, Ballwin, MO (US)

(72) Inventor: Scott David Siebers, Ballwin, MO (US)

(73) Assignee: Mr. Scott David Siebers, Ballwin, MO (US)

(21) Appl. No.: 15/292,657

(22) Filed: Oct. 13, 2016

(51) Int. Cl. G09B 7/04; G09B 19/22; A63B 24/00

(52) U.S. Cl. CPC G09B 7/04; A63B 24/0075; G09B 19/22

(57) ABSTRACT

An integrated system and method for providing play-based learning to enhance plurality of skills of first user i.e. child, and further enables second user i.e. parent to monitor the enhanced skills of the child through computing device. The method includes the step of receiving machine-readable code integrated with academic workbook through computing device. The academic workbook includes queries, and answers. Then, setting up plurality of exercise rules over computing device by second user. The exercise rules guided by computing device to second user. Then, second user instructs to first user regarding exercises. Thereafter, displaying queries contained within the academic workbook to the first user to select the possible answer. Each of the answers include individual color. Further, selecting one recreational unit from plurality of colored recreational units having color corresponding to color of selected answer. Furthermore, performing exercise by first user and then second user scores answers and exercise performance.

### TECHNICAL FIELD

The presently disclosed embodiments are related, in general, to provide play-based learning to enhance a plurality of skills. More particularly, the presently disclosed embodiments are related to methods and systems to provide play-based learning to enhance plurality of skills of a child and further enables the parent to monitor the enhanced skills through a computing device over a communication network.

### BACKGROUND

Currently, many parents must juggle their family responsibilities with highly demanding roles in the workforce as well as a multitude of other social obligations. Many parents experience stress and frustration at not being able to spend enough quality time with their children. In particular, parents are challenged to spend time helping their children academically in order to give them a solid foundation for success in school. This requires not only a time commitment but also research and education on their part in order to select and become proficient with the appropriate teaching resources. Additionally, when it comes to athletic activities/sports, parents lack the time and frequently, the knowledge or skill-sets to help their children succeed in these extracurricular activities.

The existing systems and methods often rely on workbooks, tutorials and games spanning physical and digital products. These systems and methods are not only expensive but also require high level of dedication from parents to become proficient in helping their child develop academic and athletic skills. Other existing systems and methods include private tutors, coaches and instructional camps/events which are even more expensive and financially burdensome for families. Hence, there is a need for a method and a system that enables the parents to spend quality time with their children in order to ensure the bright future of the children. Further, there is also a need for an integrated and interactive method and system to combine athletics and academics via a play-based learning system to build children's skills in both these areas.

Further limitations and disadvantages of conventional and traditional methods and systems will become apparent to one of skill in the art, through comparison of described methods and compositions with some aspects of the present disclosure, as set forth in the remainder of the present application and with reference to the drawings and Tables.

### SUMMARY

An integrated method and a system to provide play-based learning to enhance plurality of skills of a child, and further enables the parent to monitor the enhanced skills through a computing device over a communication network are provided substantially as shown in, and/or described in connection with, at least one of the figures, as set forth more completely in the claims.

According to embodiments illustrated herein, there is provided an integrated method for providing play-based learning in order to enhance plurality of skills of a first user, and further monitoring the enhanced skills by a second user through a computing device over a communication network. The method includes receiving a machine-readable code integrated with an academic workbook through the computing device. In an embodiment, the academic workbook includes plurality of queries, and plurality of answers.

The method further includes setting up plurality of exercise rules over the computing device by the second user. In an embodiment, the exercise rules guided by the computing device to the second user so as to the second user instructs to the first user regarding the exercises to be completed. Then the method includes displaying the queries contained within the academic workbook so as to the first user selects at least one possible answer, wherein each of the plurality of answers include individual color. Further, the method includes selecting at-least one recreational unit from a plurality of colored recreational units having color corresponding to the color of the selected answer. Then the method includes performing the exercise by the first user based on the set up exercise rules by the second user. Further, the method includes scoring the answers and the exercise performance by the second user through the computing device.

According to embodiments illustrated herein, there is provided an integrated system to provide play-based learning in order to enhance plurality of skills of a first user, and further monitoring the enhanced skills by a second user through a computing device configured with a host server over a communication network.

The system includes an academic workbook, a display stand, plurality of colored recreational units, and an application server. The academic workbook includes, plurality of queries, and plurality of answers. The display stand secures the academic workbook to display the queries contained within the academic workbook so as to the first user selects at least one possible answer. In an embodiment, each of the plurality of answers include an individual color. The plurality of colored recreational units enables the first user to select at-least one recreational unit corresponding to the color of the selected answer.

The application server configured with the communication network includes one or more processors. The one or more processors are configured to receive a machine-readable code integrated with an academic workbook through the computing device. The one or more processors are further configured to set up plurality of exercise rules over the computing device by the second user. In an embodiment, the exercise rules guided by the computing device to the second user so as to the second user instructs to the first user regarding the exercise to be completed. The one or more processors are further configured to score the answers and the exercise performance by the second user through the computing device.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is an environmental diagram that illustrates an integrated system to provide play-based learning in order to enhance plurality of skills of a first user, and further monitoring the enhanced skills by a second user through a computing device configured with a host server over a communication network, in accordance with at least one embodiment;

FIG. 2 illustrates a flowchart of an integrated method for providing play-based learning in order to enhance plurality of skills of a first user, and further monitoring the enhanced skills by a second user through a computing device over a communication network, in accordance with at least one embodiment;

FIG. 3 is an operational view of the integrated method and system for providing play-based learning in order to enhance plurality of skills of a first user, and further monitoring the enhanced skills by a second user through a computing device over a communication network, in accordance with at least one embodiment;

FIG. 4 is an exemplary view the display stand, in accordance with at least one embodiment;

FIG. 5 is an integrated view of the academic workbook and display stand, in accordance with at least one embodiment; and

FIG. 6 is an operational screenshot of the computing device, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

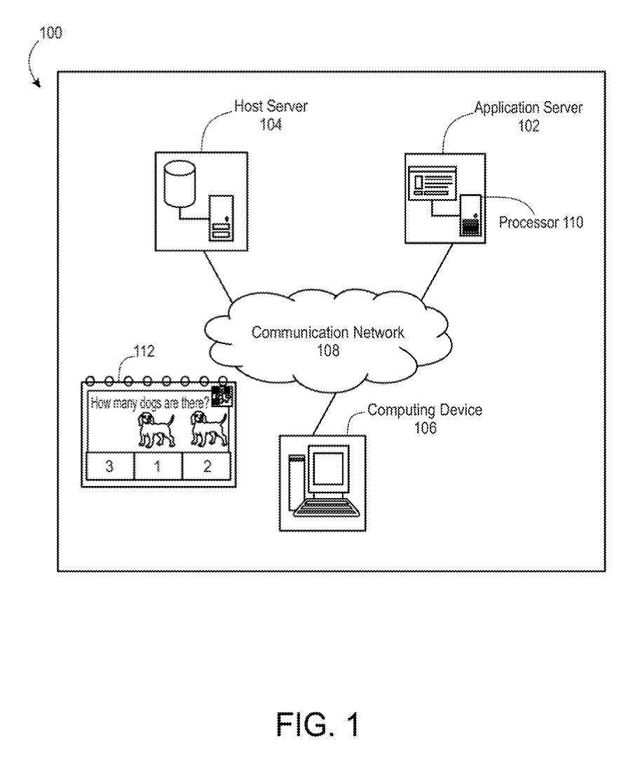

FIG. 1 is an environmental diagram that illustrates an integrated system 100 to provide play-based learning in order to enhance plurality of skills of a first user, and further monitoring the enhanced skills by a second user through a computing device 106 configured with a host server 104 over a communication network 108, in accordance with at least one embodiment. In an embodiment, the first user includes but not limited to a juvenile, kid and child. Further example of the second user includes but not limited to an adult, a parent or caretaker of the child.

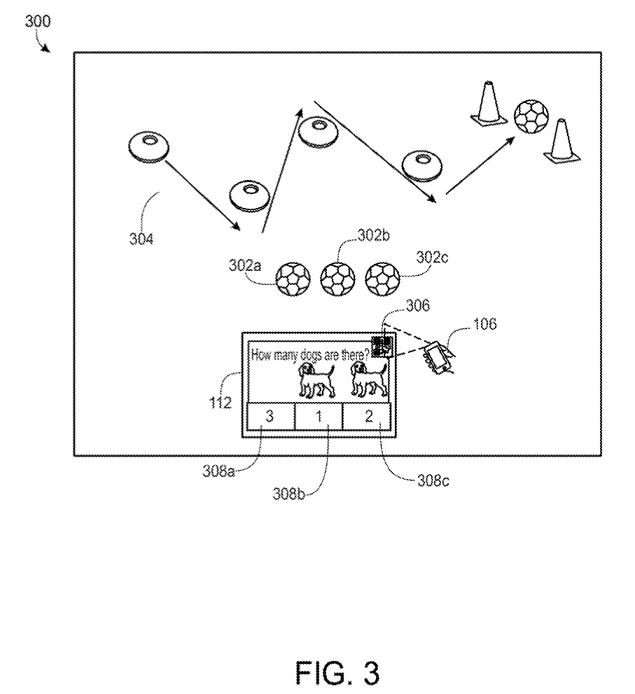

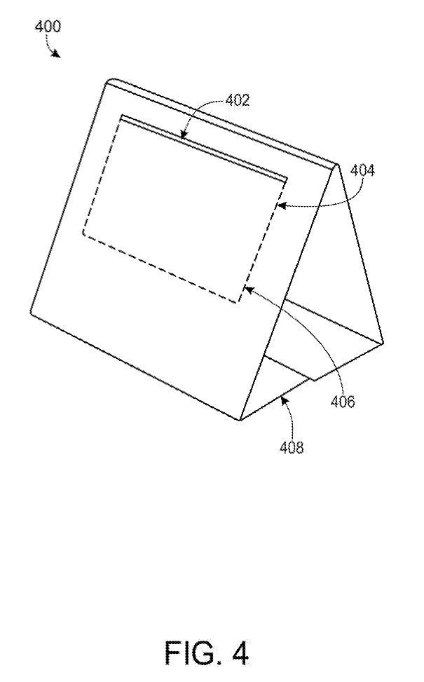

The system 100 includes an academic workbook 112, a display stand 400 (shown and explained in conjunction with FIG. 4), plurality of colored recreational units 302a, 302b, and 302c (shown and explained in conjunction with FIG. 3), and an application server 102. The academic workbook 112 includes plurality of queries, and plurality of answers. In an embodiment, the academic workbook 112 may delivered digitally either through a separate display screen or via an augmented reality device/glasses. In an example embodiment, the plurality of queries and the plurality of answers are pertaining to the various course curriculum, subjects and topics to be learned by the first user such as mathematical calculations, recognizing numbers, shapes or places, language skills, etc.

The display stand 400 secures the academic workbook 112 to display the queries contained within the academic workbook 112 so as to the first user selects at least one possible answer. In an embodiment, each of the plurality of answers include individual color. The plurality of colored recreational units 302a, 302b, and 302c enables the first user to select at-least one recreational unit corresponding to the color of the selected answer. The application server 102 configured with the communication network 108 includes one or more processors 110. The one or more processors 110 are configured to receive a machine-readable code integrated with an academic workbook through the computing device 106.

The one or more processors 110 are further configured to set up plurality of exercise rules over the computing device 106 by the second user. In an embodiment, the exercise rules guided by the computing device 106 to the second user so as to the second user instructs to the first user regarding the exercise to be completed. Examples of the exercise rules include but not limited to athletic exercise, outdoor games, indoor games or any physical exercise that helps the child to stay physically and mentally fit. In an exemplary embodiment, the instructions given by the second user to the first user may be either verbal instruction or a video illustration as to how the exercise is to be performed. Therefore, the first user and the second user may watch a short video clip together.

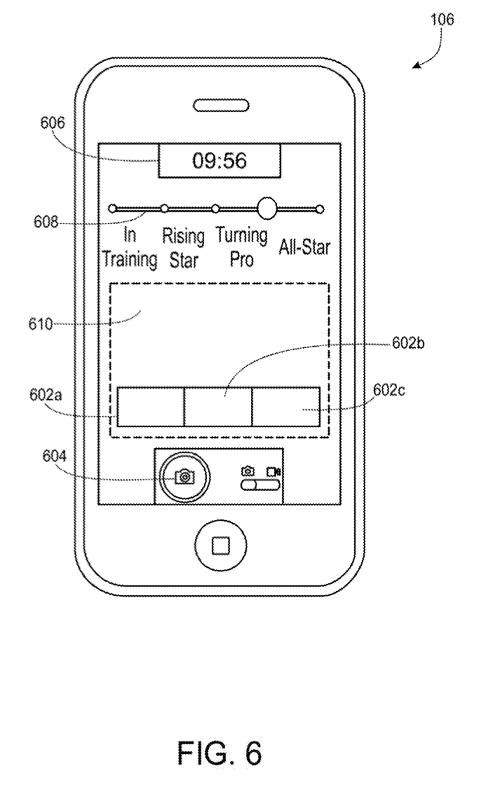

The one or more processors 110 are further configured to score the answers and the exercise performance by the second user through the computing device 106. The one or more processors 110 are further configured to receive answer by the second user through a plurality of color blocks 602a, 602b, and 602c (shown and explained in conjunction with FIG. 6) integrated with the computing device 106. In an embodiment, the color of the color blocks 602a, 602b, and 602c are corresponding to the color of the answers displayed within the academic workbook 112. In an exemplary embodiment, the computing device 106 receives a signal from the academic workbook 112 corresponding to the answer provided by the first user when the second user is grading/scoring via the computing device.

The one or more processors 110 further configured to provide tips to the first user through the computing device 106 in case of receiving the incorrect answer from the first user via the selection of colored recreational units 302a, 302b, and 302c. The one or more processors 110 further configured to provide a performance analysis report of the first user through the computing device 106. The performance analysis report may be delivered via mobile application or a linked/coordinated website. Further, the system 100 may share a periodic performance analysis report includes but not limited to over the email, text, messaging applications, social media platforms or any digital communication methods of the second user i.e. parent. Examples of the recreational units includes but not limited to plurality of basketball, plurality of soccer, plurality of football, plurality of baseball, plurality of softball, plurality of volleyball, plurality of tennis, golf, gymnastics, cheerleading, and/or combination thereof.

The one or more processors 110 further configured to provide plurality of recommendations based on the performance of the first user to the second user in order to improve the skills of the first user. In an embodiment, the plurality of skills include academic skill, and athletic skill. In an embodiment, the machine-readable code is selected from at-least one of: a QR Code, an UPC code, NFC, augmented reality, Bluetooth enabled mechanism such BLE or Bluetooth beacon, and/or combination thereof.

In an embodiment, the communication network 108 includes a medium through which a content communications host server 104, one or more network ready devices 106, and the application server 102 communicate with each other. Such a communication is performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 108 includes, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

In an embodiment, the application server 102 includes a processor 110. The processor 110 is implemented based on a number of processor technologies known in the art. Examples of the processor 110 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

In an embodiment, the application server 102 refers to a computing unit or a software framework hosting an application or a software service. In an embodiment, the application server 102 is implemented to execute procedures such as, but not limited to, programs, routines, or scripts stored in one or more memories for supporting the hosted application or the software service. In an embodiment, the hosted application or the software service is configured to perform one or more predetermined operations. The application server 102 is realized through various types of application servers such as, but not limited to, a Java application server, a .NET framework application server, a Based application server, a PHP framework application server, or any other application server framework.

The present invention should not be limited in its communication nomenclature. Exemplary operating systems include but are not limited to SymbianOS, Windows Mobile/Windows CE, Palm OS, Linux, Blackberry OS, BREW, webOS, Android, iOS, etc. which have been developed for mobile computing applications and can handle both data computing and communication applications, e.g., voice communications.

In an embodiment, the host server 104 is operable to execute one or more semantic queries to enable implementation of machine-learning techniques. The host server 104 is realized through various technologies such as, but not limited to, Microsoft® SQL Server, Oracle®, IBM DB2®, Microsoft Access®, PostgreSQL®, MySQL® and SQLite®, and the like.

Examples of the computing device 106 include, but are not limited to, a personal computer, a laptop, a personal digital assistant (PDA), a mobile device, a tablet, or iPad. A person skilled in the art will understand that the scope of the disclosure should not be limited to play-based learning in order to enhance plurality of skills and further monitoring the enhanced skills.

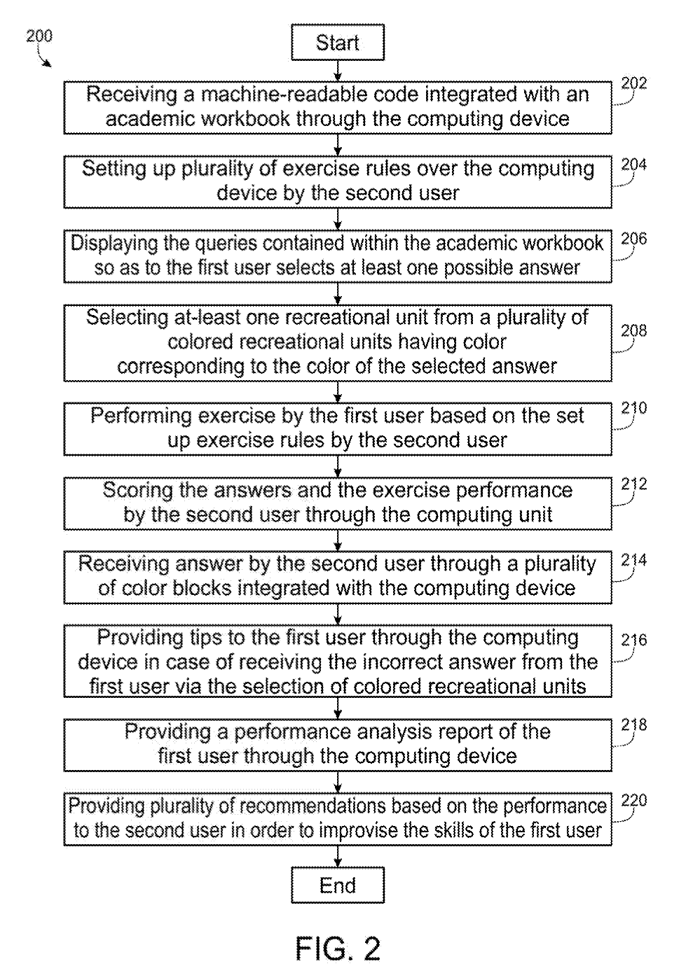

FIG. 2 illustrates a flowchart 200 of an integrated method for providing play-based learning in order to enhance plurality of skills of a first user, and further monitoring the enhanced skills by a second user through a computing device over a communication network, in accordance with at least one embodiment. FIG. 2 is explained in conjunction with FIG. 1. The method starts at step 202 of receiving a machine-readable code integrated with an academic workbook through the computing device. In an embodiment, the academic workbook includes plurality of queries, and plurality of answers.

The method further includes the step 204 of setting up plurality of exercise rules over the computing device by the second user. In an embodiment, the exercise rules guided by the computing device to the second user so as to the second user instructs to the first user regarding the exercises to be completed. Examples of the exercise rules include but not limited to athletic exercise, outdoor games, indoor games or any physical exercise that helps the child to stay physically and mentally fit.

Then the method, includes the step 206 of displaying the queries over the academic workbook so as to the first user selects at least one possible answer. Further, the method includes the step 208 of selecting at-least one recreational unit from a plurality of colored recreational units having color corresponding to the color of the selected answer.

Then the method includes the step 210 of performing exercise by the first user based on the set up exercise rules by the second user. Further, the method includes the step 212 of scoring the answers and the exercise performance by the second user through the computing unit. Thereafter the method includes the step 214 of receiving answer by the second user through a plurality of color blocks integrated with the computing device. For example, if the first user i.e. child selects the blue ball which corresponds to the answer in the physical academic workbook, then the second user i.e. parent would observe this selection of the first user to select the blue block on his/her computing device. In the event of a digital signal or augmented reality academic workbook, the computing device automatically receives or records the digital signal corresponding to the selection/answer of the first user.

The method further includes the step 216 of providing tips to the first user through the computing device in case of receiving the incorrect answer from the first user via the selection of colored recreational units. Further, the computing device also provides tips pertaining to the athletic skills in order to improve the performance of the first user. Then the method includes the step 218 of providing a performance analysis report of the first user through the computing device. Then the method includes the step 220 of providing plurality of recommendations based on the performance to the second user in order to improvise the skills of the first user.

FIG. 3 is an operational view 300 of the integrated method and system 100 for providing play-based learning in order to enhance plurality of skills of a first user, and further monitoring the enhanced skills by a second user through a computing device 106 over a communication network 108, in accordance with at least one embodiment. FIG. 3 is explained in conjunction with FIG. 1 and FIG. 2. The computing device 106 receives a machine-readable code 306 (QR code or UPC code) integrated with the academic workbook 112. The academic workbook 112 includes plurality of queries, and plurality of answers.

Then the second user i.e. parent set up plurality of exercise rules over the computing device 106. The exercise rules are guided by the computing device 106 to the second user so that the second user instructs to the first user regarding the exercises 306 (shown as an example) to be completed. Examples of the exercise rules include but not limited to athletic exercise, outdoor games, indoor games or any physical exercise that helps the child to stay physically and mentally fit.

The academic workbook 112 displays the queries so that the first user selects at least one possible answer. Then the first user i.e. child selects at-least one recreational unit from a plurality of colored recreational units 302a, 302b, and 302c having color corresponding to the color of the selected answer 308a, 308b, and 308c. Then the first user performs the exercise based on the exercise rules set up by the second user. Thereafter the second user scores or grades the answers and the exercise performance through the computing device 106.

FIG. 4 is an exemplary view of the display stand 400, in accordance with at least one embodiment. The display stand 400 includes an opening 402 to accept a rear cover of flip chart i.e. academic workbook. The display stand 400 is collapsible, weatherproof and having a freestanding display. The display stand 400 further includes an internal “sleeve” 404 in order to receive/insert back cover of academic workbook. The display stand 400 further includes a “pocket” 406 slidably secures the rear cover of flip chart to keep flip chart in place. Further, the display stand 400 includes a fastening mechanism 408 such as Velcro to allow the display stand 400 to collapse, and fold together. Example of display stand 400 is the field stands commonly used in American football fields.

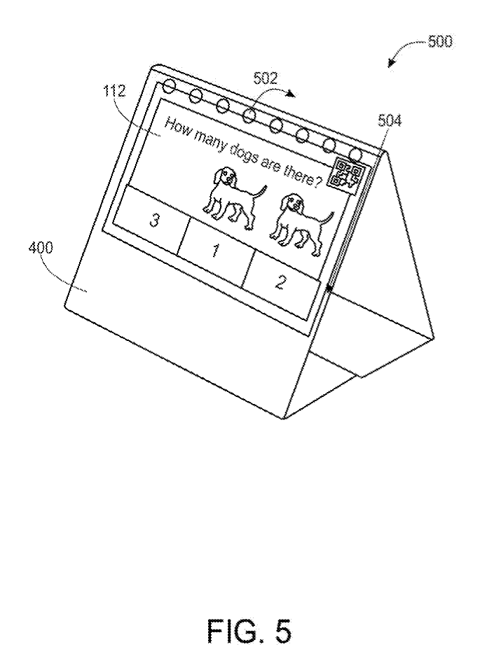

FIG. 5 is an integrated view 500 of the academic workbook 112 and display stand 400, in accordance with at least one embodiment. The academic workbook 112 or the flip chart includes plurality of rings 502. The flip chart rings 502 are large enough to allow the page to clear the width of the display stand 400. Therefore, the turned page would lay flat against rear side of display stand 400. Further, the rear cover of the academic workbook 112 slides down 504 into “sleeve” 404 (shown in FIG. 4). Thus, the positioning of the academic workbook 112 is towards top of larger field stand to improve the visibility, and line of sight.

FIG. 6 is an operational screenshot of the computing device 106, in accordance with at least one embodiment. The screenshot shows the running timer 606 to keep track the time spent to complete the workbook task and exercise performed. In a preferred embodiment, a pre-set time is 30 minutes to complete the task and exercise. Further, the screenshot shows a slider scale 608 for parent to rate the athletic progress during drill. The screenshot further shows a window 610 to provide the parents with bullet point tips on performing athletic drill. The window 610 toggles to academic tips based on the color-coded scoring. Then the screenshot further shows plurality of color blocks 602a, 602b, and 602c so that the parents may answer or select the correct color block as their child answers each question in order to keep the score. Furthermore, the parent may capture photos or videos through a camera module 604 shown in the screenshot

Thus the present method and system enables the children to advance not only academically and but also athletically by spending fun, quality time with their parents. The present system and method also provide the parents with a complete teaching curriculum (sports and academics), teaching tips, and a method for tracking the performance of their children.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. An integrated method for providing play-based learning in order to enhance plurality of skills of a first user, and further monitoring the enhanced skills by a second user through a computing device over a communication network, the method comprising the steps of:
receiving a machine-readable code integrated with an academic workbook through the computing device, wherein the academic workbook includes plurality of queries, and plurality of answers;
setting up plurality of exercise rules over the computing device by the second user, wherein the exercise rules guided by the computing device to the second user so as to the second user instructs to the first user regarding the exercises to be completed;
displaying the queries contained within the academic workbook so as to the first user selects at least one possible answer, wherein each of the plurality of answers include individual color;
selecting at-least one recreational unit from a plurality of colored recreational units having color corresponding to the color of the selected answer;
performing exercise by the first user based on the set up exercise rules by the second user; and
scoring the answers and the exercise performance by the second user through the computing device.

2. The method according to claim 1 further includes the step of receiving answer by the second user through a plurality of color blocks integrated with the computing device, wherein the color of the color blocks are corresponding to the color of the answers displayed within the academic workbook.

3. The method according to claim 1 further includes the step of providing tips to the first user through the computing device in case of receiving the incorrect answer from the first user via the selection of colored recreational units.

4. The method according to claim 1 further includes the step of providing a performance analysis report of the first user through the computing device.

5. The method according to claim 1 further includes the step of providing plurality of recommendations based on the performance to the second user in order to improve the skills of the first user.

6. The method according to claim wherein the plurality of skills include academic skill, and athletic skill.

7. The method according to claim 1 wherein the first user is a juvenile and a second user is adult.

8. An integrated system to provide play-based learning in order to enhance plurality of skills of a first user, and further monitoring the enhanced skills by a second user through a computing device configured with a host server over a communication network, the system comprising:
an academic workbook includes plurality of queries, and plurality of answers;
a display stand secures the academic workbook to display the queries contained within the academic workbook so as to the first user selects at least one possible answer, wherein each of the plurality of answers include individual color;
plurality of colored recreational units enables the first user to select at-least one recreational unit corresponding to the color of the selected answer; and
an application server configured with the communication network includes one or more processors configured to:
receive a machine-readable code integrated with an academic workbook through the computing device;
set up plurality of exercise rules over the computing device by the second user, wherein the exercise rules guided by the computing device to the second user so as to the second user instructs to the first user regarding the exercise to be completed; and
score the answers and the exercise performance by the second user through the computing device.

9. The one or more processors according to claim 8 further configured to receive answer by the second user through a plurality of color blocks integrated with the computing device, wherein the color of the color blocks are corresponding to the color of the answers displayed within the academic workbook.

10. The one or more processors according to claim 8 further configured to provide tips to the first user through the computing device in case of receiving the incorrect answer from the first user via the selection of colored recreational units.

11. The one or more processors according to claim 8 further configured to provide a performance analysis report of the first user through the computing device.

12. The one or more processors according to claim 8 further configured to provide plurality of recommendations based on the performance to the second user in order to improve the skills of the first user.

13. The system according to claim 8 wherein the plurality of skills include academic skill, and athletic skill.

14. The system according to claim 8 wherein the first user is a juvenile and a second user is adult.

15. The system according to claim 8 wherein the machine-readable code is selected from at-least one of: a QR Code; an UPC code; NFC; augmented reality; Bluetooth enabled mechanism and/or combination thereof.
